(19) United States
(12) Patent Application Publication
(10) Pub. No.: US 2024/0423240 A1
(43) Pub. Date: Dec. 26, 2024

(54) SYSTEM AND METHOD FOR FOOD WASTE COMBINATIONS WITH BROMOFORM-CONTAINING SEAWEEDS

(71) Applicant: Timothy Childs, San Francisco, CA (US)

(72) Inventor: Timothy Childs, San Francisco, CA (US)

(21) Appl. No.: 18/668,074

(22) Filed: May 17, 2024

Related U.S. Application Data
(60) Provisional application No. 63/467,580, filed on May 18, 2023.
(60) Provisional application No. 63/467,581, filed on May 18, 2023.

(51) Int. Cl. A23K 10/10; B01D 11/02

(52) U.S. Cl. CPC A23K 10/10; B01D 11/0288

(57) ABSTRACT

The present invention is directed to a novel food waste combination with bromoform-containing seaweeds that benefit livestock nutrition and reduce greenhouse gas emissions. Each combination of food waste begins with bromoform-containing seaweeds that reduce greenhouse gas emission and a non-obvious food waste stream that can synergistically reduce greenhouse gas emissions while delivering nutrient benefits including proteins from the same seaweed to the animal. These combinations further increase agricultural efficiency, reduce greenhouse gasses emitted from rotting food waste, and in general provide benefits to society by reducing the amount of arable land required to feed humans and animals by redirecting waste into productive use in the economy.

### CROSS REFERENCE TO RELATED APPLICATIONS

This application claims the benefit of U.S. Provisional Patent Application Ser. No. 63/467,580, filed May 18, 2023, and U.S. Provisional Patent Application Ser. No. 63/467,581 filed on May 18, 2023, the contents of which are incorporated herein by reference.

### BACKGROUND OF THE INVENTION

The present invention is directed to a novel food waste combination with bromoform-containing seaweeds that benefit livestock nutrition and reduce greenhouse gas emissions. Each combination of food waste begins with bromoform-containing seaweeds that reduce greenhouse gas emission and a non-obvious food waste stream that can synergistically reduce greenhouse gas emissions while delivering nutrient benefits including proteins from the same seaweed to the animal. These combinations further increase agricultural efficiency, reduce greenhouse gasses emitted from rotting food waste, and in general provide benefits to society by reducing the amount of arable land required to feed humans and animals by redirecting waste into productive use in the economy.

An advancement in the field of sustainable agriculture, especially one addressing critical challenges related to both livestock nutrition and greenhouse gas emissions mitigation is much needed in the field of invention. The escalating global demand for livestock products has placed significant strain on agricultural resources, with particular reference to arable land. Concurrently, the negative environmental impacts of livestock farming, including methane emissions from enteric fermentation and decomposition of organic waste, have intensified the concerns of industries, activists, and individuals alike regarding climate change and resource sustainability.

A plethora of traditional approaches have been employed to mitigate these challenges. Dietary modifications for livestock, waste management strategies, and initiatives aimed at improving agricultural efficiency have all been previously employed. However, existing remedies often fall short in providing comprehensive solutions. While dietary adjustments can influence methane emissions from animals to some extent, they typically overlook the overarching issue of food waste decomposition, which is a persistent and significant contributor to greenhouse gas emissions.

Conventional waste management practices often involve disposal methods such as landfilling or incineration, which not only fail to harness the vast potential value of organic waste but degrade the environmental landscape and rapidly deplete available resources, damaging the environment and access to organic compost. The production of feed crops exacerbates competition with food crops, which consequently increases concerns over land use efficiency and food security.

In lieu of these challenges, the present invention offers a novel and holistic approach to address issues of livestock nutrition and food waste management by capitalizing on the synergistic effects of their components to achieve multiple objectives simultaneously. The combinations disclosed herein enhance agricultural efficiency, diminish greenhouse gas emissions from decomposing food waste, and offer a multitude of benefits by diminishing the necessity for arable land to sustain animal and human populations by repurposing waste into a valuable, nutrient-rich, economic asset.

In summary, the present solution offers livestock nutrition by way of food waste management that in turn reduces greenhouse gas emissions. By leveraging the synergies between bromoform-containing seaweeds and food waste streams, the viable remedy addresses the limitations of existing approaches while promoting resource efficiency, environmental stewardship, and agricultural resilience. By connecting restaurants, individuals, and farms, the present system produces an efficient redistribution of food waste that can open the door to significantly transformative outcomes.

### SUMMARY OF THE INVENTION

The present invention pertains to a system and method for combining bromoform-containing seaweeds with food waste to create a feed that delivers nutrients to livestock while simultaneously improving gut health in the animal.

Bromoform is a naturally occurring compound that is found in select seaweeds, known for its ability to reduce methane emissions from livestock. The bromoform found in seaweeds inhibits methanogenesis by interfering with the activity of the methanogenic archaea in the rumen of livestock, which is the fermentation chamber located in the digestive system of ruminant or livestock animals such as cattle, sheep and goats. This chamber is responsible for digestion of plant material and thus, methane production.

By inhibiting the growth and the activity of methanogenic archaea in livestock, methane production is also reduced. Bromoform alters the composition and the movement in the digestive tract which can change processes pertaining to fermentation and reduces the availability of hydrogen by diverting it towards alternate metabolic pathways. Succinctly, the bromoform found in select seaweeds have bioactive compounds and provide alternative channels for digestive activity in livestock that would otherwise produce substantial methane emissions if not present. As such, the present invention utilizes the unique compounds inherent in bromoform to produce the sustainable model disclosed.

The present invention provides novel food waste combinations with bromoform containing seaweeds that synergistically reduce greenhouse gas emissions from livestock.

The combination of up-cycled food waste streams and bromoform produce novel benefits to livestock, and which can be distributed as animal feed products. Each combination provided in the present invention begins with bromoform-containing seaweeds that have been proven to reduce greenhouse gas emission for the reasons above and combines it with a non-obvious food waste stream that can synergistically reduce greenhouse gas emissions while delivering nutrient benefits. As stated, these benefits include an exhaustive list-including providing proteins from the seaweed it originates from to the animal.

Food waste stream combinations include but are not limited to: wine pomace, carrot pomace, garlic waste, oregano waste, chestnut leaves, chestnut tannins, acacia mearnsii, and schinopsis balansae tannin extracts. Tannins provide antioxidant properties that help with oxidative stress and inflammation whereas proteins are well known to assist in overall animal development, muscle growth and metabolism. By combining food waste streams in various quantities with bromoform-containing red seaweed can reduce methane emissions from livestock by 40% or greater while providing beneficial nutrients to the animals including proteins and tannins, the present solution offers a unique pathway for channeling both the beneficial characteristics of bromoform with up-cycled food waste that comprise of nutrient-rich properties that would otherwise go to waste.

By integrating these seaweeds with diverse food waste streams, the present remedy not only reduces methane emissions associated with waste decomposition but also aids in the conversion of organic waste into livestock feed ingredients, thus effectively converting it into an economic asset.

The typical bromoform extraction process occurs by using organic solvents, such as chloroform or dichloromethane. Other mediums such as steam distillation can be utilized to separate the bromoform from the seaweed using water vapor as a carrier from the seaweed matrix. Immiscible solvents with solubility distinctions can also be utilized in the extraction process if the food waste is liquid, in which a liquid-liquid extraction technique is better suited. Following the extraction process are purification steps and distillation steps to prevent interference of crude extract. Further, techniques to appropriately quantify concentration levels of the bromoform in order to produce an adequate dosage or measurement per the quantity of food waste is also employed to ensure consistency and purity throughout.

In one embodiment of the present invention, the food waste may derive from a plethora of restaurants wherein food waste can be spared and incorporated with bromoform mixtures. This is especially beneficial for farm-fresh or farm-to-table type establishments which already work in collaboration with local farms for their dairy, produce and livestock. The present solution can operate as an intermediary between restaurants and farms, individuals and farms, individuals and restaurants, individuals, restaurants and farms, among many other combinations and channels for food waste.

Within this system, surplus food from a diverse array of culinary establishments, including farm-fresh and farm-to-table enterprises, is strategically repurposed through integration with bromoform mixtures. As such, the sustainability practice helps support symbiotic relationships within local agricultural ecosystems between individuals using an application and wanting to help compost or get rid of their food waste and restaurants and farms that can lower their carbon footprint while also electing for a more economically viable option.

Halogenated methane analogues, including bromoform, have been shown to inhibit methane formation in the rumen of both cows and sheep. For example, and not by way of limitation, the red seaweed A. taxiformis effectively reduces methane production in vitro gas production systems with 99% reduction in methane production and an inclusion rate of 2% organic matter basis. The most likely bioactive compound that is responsible for the observed reductions in methane emissions that is present in sufficient quantities in A. taxiformis was bromoform. The underlying mechanism might be related to the reduced efficiency of the cobamide-dependent methyltransferase by interacting with reduced vitamin B12, a crucial step in methanogenesis in the rumen. In vivo research with sheep has shown an 80% reduction in methane emission by A. taxiformis.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a flow chart outlining the method of methane reduction.

FIGS. 2A-D are charts of potential waste stream combinations.

FIG. 3 depicts the seaweed harvesting and extraction process.

FIG. 4 is a diagram that depicts how bromoform inhibits methanogenesis.

FIG. 5 provides an overview of a standard equipment used in embodiments of the bromoform purification and extraction process, as well as the food waste streams deriving from customers, establishments and farms.

FIG. 6 is a flow chart depicting the combination of biochar and red seaweed bromoform.

### DETAILED DESCRIPTION OF THE PREFERRED EMBODIMENT

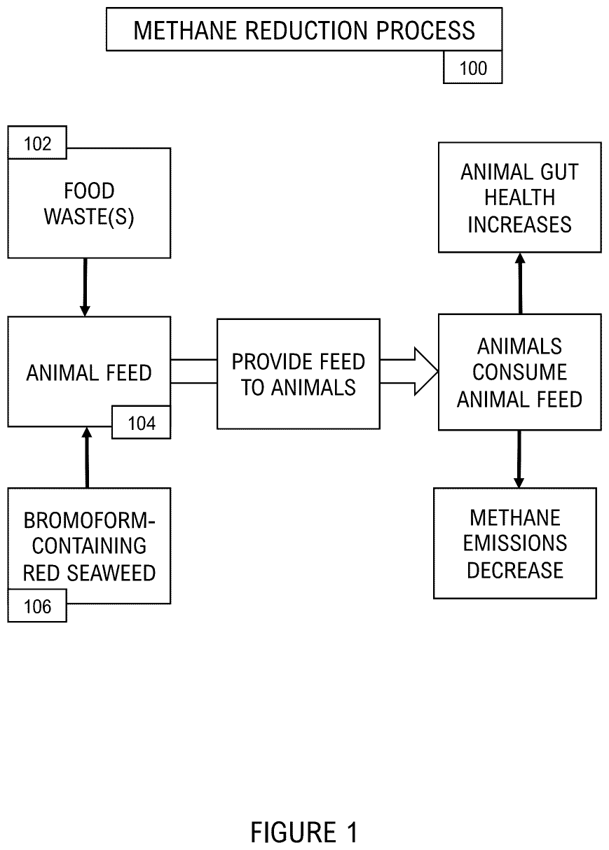

FIG. 1 is a flow chart outlining the method of methane reduction. In accordance with the preferred embodiment of the present invention, a unique food waste recipe is combined with bromoform-containing red seaweed to produce an animal feed product. This animal feed is then delivered to the animals for consumption. As this feed is integrated into the animal's diet, the unique combination of nutrient-rich food wastes and bromoform-containing red seaweed improves the animal's overall gut health and decreases the methane emissions produced by the animals.

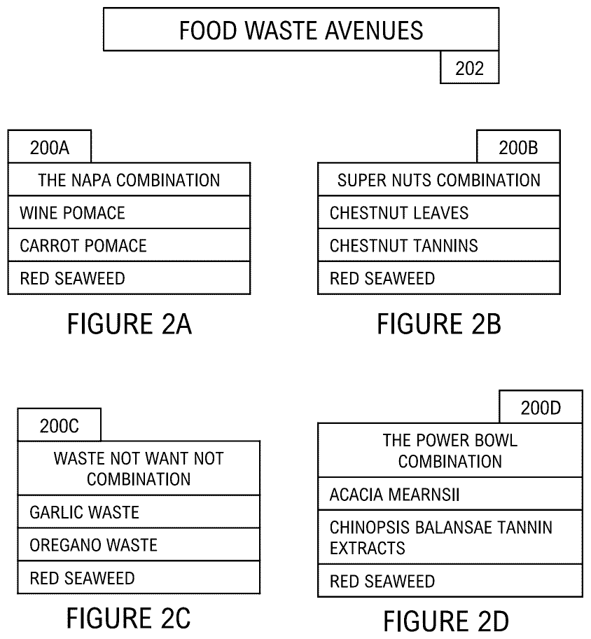

FIGS. 2A-D is a chart of potential waste stream combinations. In accordance with the preferred embodiment of the present invention, there are several recipes for food waste combinations that provide nutrient rich animal feed product. Potential food waste combinations include wine pomace and carrot pomace, garlic waste and oregano waste, chestnut leaves and chestnut tannins, and Acacia mearnsii and schinopsis balansae tannin extracts. Combining these food waste streams with bromoform-containing red seaweed creates an animal feed product that contains beneficial nutrients and acts to reduce the amount of methane emitted from the animals. These combinations are provided by way of example and are not meant to limit the scope of the present invention. In accordance with alternative embodiments of the present invention, other food waste combinations may be used as a nutrient-rich, methane-reducing animal feed including solid agricultural waste, liquid agricultural waste, solid forestry waste, liquid forestry waste, and other forms of organic byproducts.

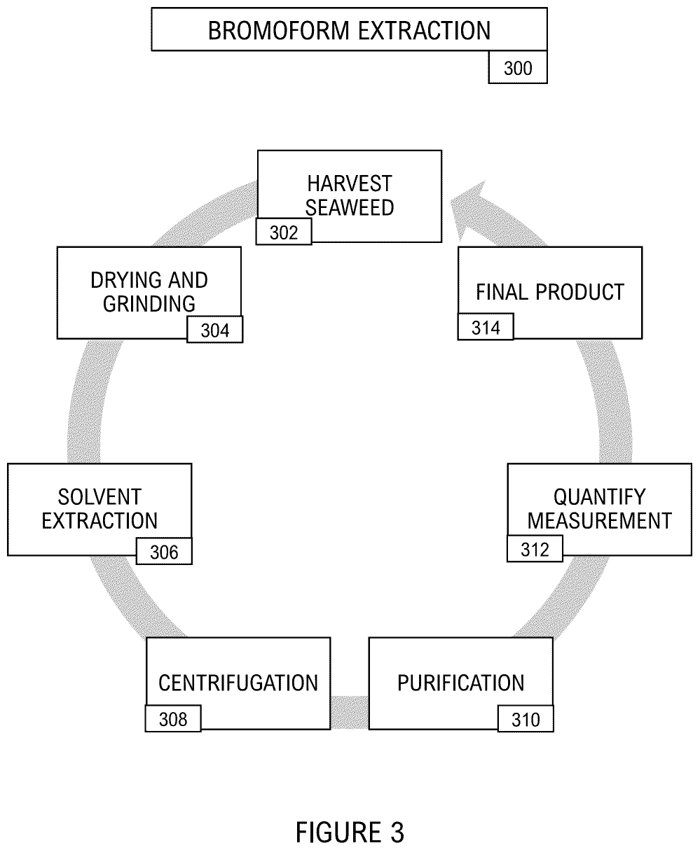

FIG. 3 depicts the extraction process for harvesting seaweed 300 of the bromoform from seaweed. After harvesting the seaweed 300, the process initiates when seaweed containing the bromoform, such as red seaweed is harvested 302. Once harvested 302, drying and grinding 304 ensures the seaweed is prepared for extraction by reducing moisture content and breaking it down into particles. During solvent extraction 306, organic solvents are employed to extract bromoform from the dried seaweed material, harnessing its solubility properties. The resulting solution undergoes centrifugation 308, where centrifugal force separates the solvent containing bromoform from the solid residue, thus enabling the purification 308 process. In this purification 308 stage, impurities are removed, which in turn yields a more concentrated and refined bromoform extract for mixture with various food waste or biodegradable, or other nutrient-rich biomaterials that is capable of being mixed with the refined bromoform extract for animal sustenance. Following purification, the method relies on quantifying measurements 310 by way of analytical testing to ensure the concentration and purity of bromoform meet desired specifications using various solvents. Some example solvents include hexane, chloroform, or other oil-based solvents to help mitigate any environmental damage or displacement caused by the removal of red seaweed or bromoform containing seaweed from the natural environment, as oil-based extraction approaches require less seaweed and yield more extraction. The final product 312 is the extracted bromoform, which can be used as standalone compound. The present invention uses the bromoform in combination with food waste, as described in related processes.

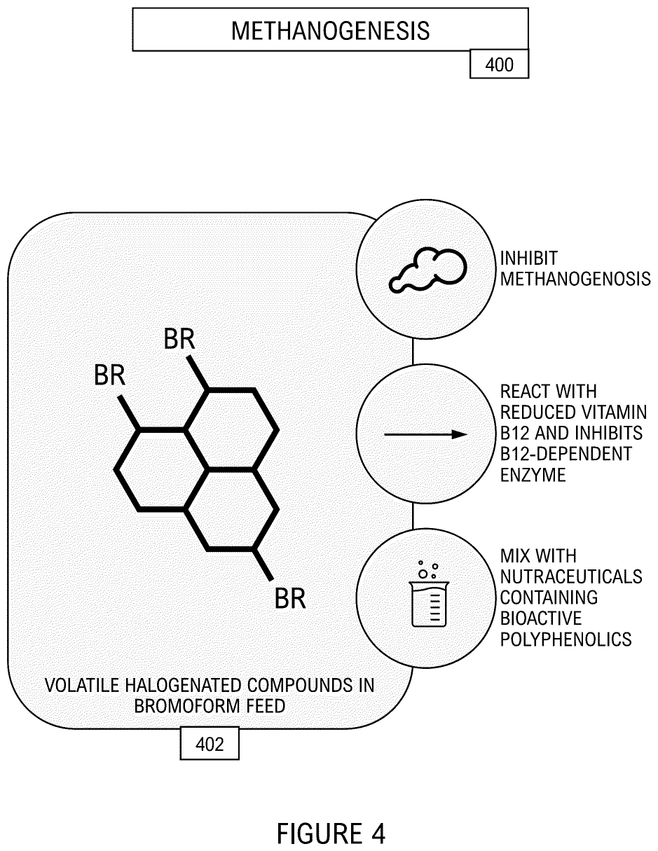

FIG. 4 depicts how bromoform inhibits methanogenesis 400. Methanogenesis 400 is the process by which methane is produced in the rumen of ruminant animals. By targeting key steps in methanogenesis, specifically with volatile halogenated compounds 402 found in bromoform feed, the compounds effectively disrupt the microbial activity and enzyme functions that are critical for methane production. Furthermore, by incorporating nutraceuticals containing bioactive polyphenolics, such as Acacia mearnsii extract, the outcome is enhanced ruminant production and quality. These polyphenolic compounds exhibit antimicrobial properties and promote beneficial changes in rumen microbial populations, leading to improved feed efficiency and nutrient utilization.

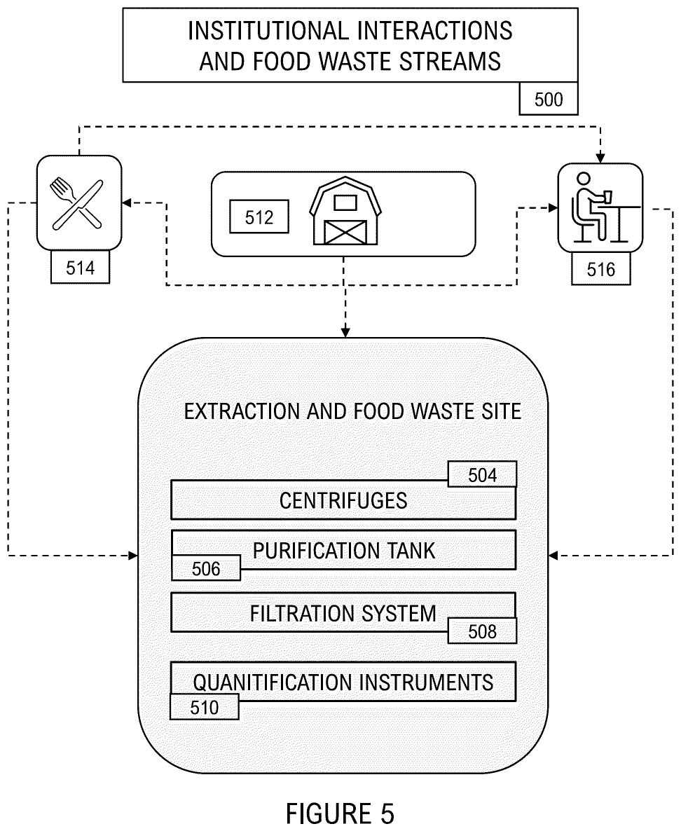

FIG. 5 provides an overview of a standard equipment used in embodiments of the bromoform purification and extraction process, as well as the institutional interactions 500 of the present system and method. Further, the figure showcases an example of an extraction and composting center layout 502 which comprises of equipment and machinery such as centrifuges 504, filtration systems 506, purification tanks 508, and a plurality of quantification instruments 508 such as silos and tubes. Farms 512 can provide food to restaurants and establishments 514 which can then in turn provide them to customers 514. These customers 516 can order to dine in at home and provide their waste to a food waste facility or composing center which may be aerobic or anaerobic, relying on either oxygen rich conditions or oxygen deprived conditions. Additionally, farms 512 can also directly offer produce to customers 516.

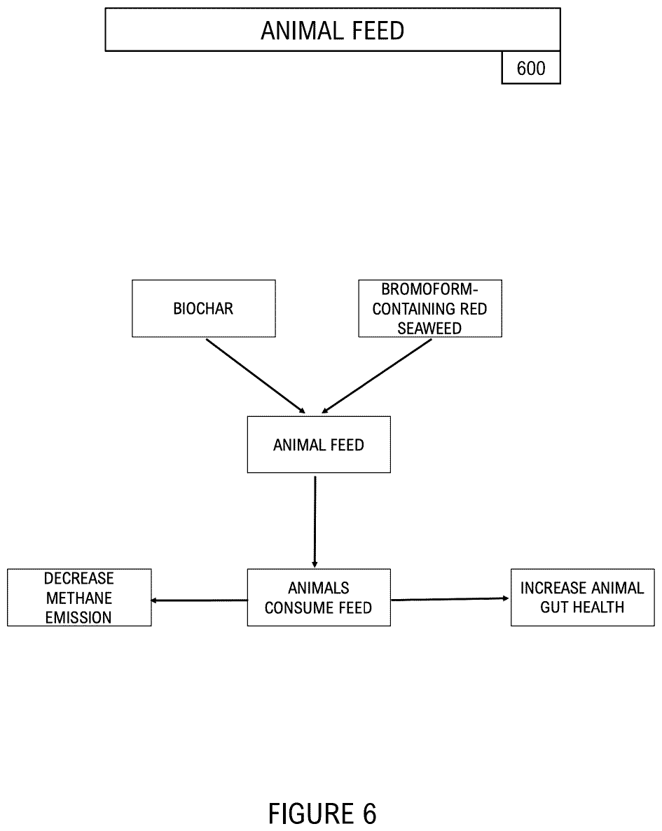

FIG. 6 is a flow chart depicting the combination of biochar and red seaweed bromoform. In accordance with the preferred embodiment of the present invention, biochar is combined with bromoform-containing red seaweed to produce an animal feed that is rich in nutrients and capable of decreasing the amount of methane-produced in the gut of the animal or animals consuming the feed. Biochar is known to have beneficial gut health effects on ruminant farm animals including but not limited to sheep and cows. Seaweeds have significant biopolymer biomass with known prebiotic and gut health effects. The present invention provides a novel combination of these two ingredients in the production of animal feed that will work to simultaneously provide quality nutrients to the animals and decrease their methane emissions.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for composting food waste using combinations of bromoform-containing seaweed extracts to ruminate livestock, the system comprising:
an extraction unit for sourcing bromoform-containing compounds from seaweed containing said bromoform-containing compounds;
wherein a drying unit and grinding unit is configured to said extraction unit for using oil-based solvents; and
a purification unit to retrieve a purified form of said bromoform-containing compound;
a food waste collection unit;
a composting unit; and
a bonding agent to combine said food waste with said extracted bromoform-containing compound.

2. The system of claim 1, wherein said bromoform-containing compound is an oil-based extract to manage an extended-release dosage and appropriate quantity needed to mix with said food waste.

3. The system of claim 1, wherein the composting unit comprises aerobic or anaerobic composting facilities.

4. The system of claim 1, wherein said extraction unit for said extraction of said bromoform-containing compound is carried out using hexane as an oil-based solvent.

5. The system of claim 4, further comprising of said extraction unit using chloroform as said oil-based solvent.

6. The system of claim 1, wherein said food waste is converted into livestock feed.

7. The system of claim 1, wherein said food waste interacts with said bromoform-containing compounds and inhibit b12-dependent enzymes when interacting with food waste nutraceuticals containing bioactive polyphenolics.

8. A method for composting food waste using combinations of bromoform-containing seaweed extracts to ruminate livestock, the method comprising:
sourcing bromoform-containing compounds from seaweed containing said bromoform-containing compounds through an extraction unit;
wherein a drying unit and grinding unit is configured to said extraction unit for using oil-based solvents; and
a purification unit to retrieve a purified form of said bromoform-containing compound;
collecting said food waste in collection unit from a plurality of food-distributing establishments;
composting said food waste in a composting unit so that it may be amalgamated with said bromoform-containing compound; and
combining, by way of a bonding agent, said food waste with said extracted bromoform-containing compound.

9. The method of claim 8, wherein said bromoform-containing compound is an oil-based extract to manage an extended-release dosage and appropriate quantity needed to mix with said food waste.

10. The method of claim 8, wherein the composting unit comprises aerobic or anaerobic composting facilities.

11. The method of claim 8, wherein said extraction unit for said extraction of said bromoform-containing compound is carried out using hexane as an oil-based solvent.

12. The method of claim 11, further comprising of said extraction unit using chloroform as said oil-based solvent.

13. The method of claim 8, wherein said food waste is converted into livestock feed.

14. The method of claim 8, wherein said food waste interacts with said bromoform-containing compounds and inhibits b12-dependent enzymes when interacting with food waste nutraceuticals containing bioactive polyphenolics.

15. A system for composting food waste using combinations of bromoform-containing seaweed extracts to ruminate livestock, the system comprising:
an extraction unit for sourcing bromoform-containing compounds from seaweed containing said bromoform-containing compounds;
wherein a drying unit and grinding unit is configured to said extraction unit for using a plurality of oil-based solvents, and wherein at least one of said oil-based solvents is hexane and/or chloroform; and
a purification unit to retrieve a purified form of said bromoform-containing compound;
a food waste collection unit;
a composting unit, wherein said composting unit supports growth of aerobic microorganisms and anaerobic microorganisms; and
a bonding agent to combine said food waste with said extracted bromoform-containing compound.

16. The system of claim 15, wherein said bromoform-containing compound is an oil-based extract to manage an extended-release dosage and appropriate quantity needed to mix with said food waste.

17. The system of claim 15, wherein said extraction unit comprises a solvent extraction vessel or column attached to a siphon for liquid-to-liquid extraction.

18. The system of claim 15, wherein tannin extracts are combined with said bromoform-containing compound to produce probiotic power support feed for livestock.

19. The system of claim 15, wherein said system comprises of a plurality of food waste streams.

20. The system of claim 19, further comprising of said food waste stream including restaurants, farms, and individuals.
